(19) United States
(12) Patent Application Publication
(10) Pub. No.: US 2007/0296793 A1
(43) Pub. Date: Dec. 27, 2007

(54) Checker for print paper sheets

(75) Inventor: Eri Matsumura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Yugen-Kaisya NOA, Tokyo (JP)

(21) Appl. No.: 11/605,543

(22) Filed: Nov. 29, 2006

(30) Foreign Application Priority Data
Jun. 27, 2006 (JP) 2006-176607

(51) Int. Cl. B41J 2/01

(52) U.S. Cl. 347/104

(57) ABSTRACT

A print paper sheet checker includes a supply portion for supplying print paper sheets, a feeding mechanism and a feeding path that feed the print paper sheets set in the supply portion one by one, a check sensor provided to the feeding path, a stacker for successively accommodating print paper sheets passed through the feeding path, a display portion for making various kinds of displays and plural operating switches. As the print paper sheets to be checked, plural kinds of tickets are set to be adaptable in advance and any ticket type can be further added.

### BACKGROUND OF THE INVENTION

1. Field of the Invention

The present invention relates to a checker for print paper sheets, particularly a checker for bank bills of respective countries including Japan, etc., and also relates to a print paper sheet checker that can register bank bills of desired countries or various kinds of marketable securities such as coupons for goods, beer coupons at the user side and also judge at the user side whether these materials are fake or genuine.

2. Description of the Related Art

There has been known a checker for feeding a print paper sheet as a target, achieving detection data from the print paper sheet concerned by using a magnetic or optical sensor and then comparing the detection data with data of true one, thereby identifying and judging whether the target is fake or genuine. An identifying machine set up in an automatic dispenser, a lending machine, a change machine or the like, a checker set up in finance institution, each of various kinds of stores or the like is known as such a device.

However, particularly the checker out of the above devices described above is designed as a single type which limits the check to target to only the types of tickets (including bank bills) of a specific country. Therefore, when the ticket types of plural countries are targeted to be checked, respective checkers corresponding to the respective countries must be independently set up. In addition, with respect to specific print paper sheets, there exists no checker that can be exceptionally adapted to these print paper sheets, and thus a checker must be newly manufactured as occasion demands.

Furthermore, a conventional checker is designed in a relatively large-sized and set up under the restriction caused by the mechanism thereof, etc., and thus it needs a broad setup space. In addition, with respect to euro notes having bank bill types different in width, it is difficult to check these bank bill types under the state that these bank bill types are mixed with one another because it is difficult to align the bank bills with one another, and also print paper sheets whose data have faded through circulation may be detected as counterfeit bills.

### SUMMARY OF THE INVENTION

In order to attain the above object, according to the present invention, a print paper sheet checker comprises a supply portion for supplying print paper sheets, a feeding mechanism and a feeding path that feed the print paper sheets set in the supply portion one by one, a check sensor provided to the feeding path, a stacker for successively accommodating print paper sheets passed through the feeding path, a display portion for making various kinds of displays and plural operating switches, wherein as the print paper sheets to be checked, plural kinds of tickets are set to be adaptable in advance and any ticket type can be further added.

In the print paper sheet checker, the operating switches include at least a type switch, a select switch, a clear switch and a start/stop switch that are designed as push button types. In the print paper sheet checker, the type switch successively switches the association with plural registered ticket types and is equipped with an other mode, data of any genuine ticket type being storable in a memory by operating the other mode.

In the print paper sheet checker, the memory for registering the data of any genuine ticket type is a flash memory.

In the print paper sheet checker, the supply portion of the checker is equipped with an auxiliary guide bar adapted to large-size print paper sheets.

In the print paper sheet checker, the supply portion of the checker is equipped with a print paper sheet pressing plate that is urged by a spring and bent in an obtuse angle.

The print paper sheet checker further comprises a feed roller having jags formed on the outer peripheral surface thereof, a flat portion being formed on a part of the outer peripheral surface of the feed roller and a one-way clutch is installed in the feed roller. The print paper sheet checker further comprises a brake roller containing a one-way clutch and a brake member that is urged against the brake roller by a spring and arranged in a comb-shape, the brake roller and the brake member being provided in a feed path subsequent to the feed roller. The print paper sheet checker further comprises a pinching roller that is urged and pressed against the feed roller by a spring.

In the print paper sheet checker, the stacker is located to be slightly lower than the feed path. The stacker is equipped with an aligning guide that is urged by a spring and bent in an obtuse angle, and a limit switch pressed by the aligning guide. The stacker is slidable to the front side.

In the print paper sheet checker, the stacker is designed to be inclined. The auxiliary guide bar is designed to be rotatable by pivoting one end thereof or detachable by using a screw. The pressing plate is equipped with a slidable link mechanism and a tension coil spring. To the feed roller a light load is applied by a leaf spring at all times. Some degree of interval is formed between the pressing plate and the feed roller in a standby state, and a feed motor rotates in the forward/reverse direction and is provided with a cam that is delinked on the basis of the rotational direction of the feed motor. The stacker is held by a ball plunger. The supply portion is provided with a detection sensor switch so as to enable automatic start.

In the print paper sheet checker, information on a feature portion of a suspicious ticket type is installed in a program, suspicious ticket information is memorized in advance, and high-precision fake or genuine judgment which is not affected by stain, ruck, fold line and aged deterioration is performed on the basis of an algorithm by software and hardware. Data values are achieved from a print paper sheet inserted and loaded from the supply portion by a judging sensor, and a fake or genuine judgment is carried out by software and hardware on the basis of the algorithm corresponding to stain, ruck, fold line, aged deterioration, etc. which are caused by circulation in the market. The print paper sheet checker further comprises a unit for correcting the output of a photodetecting sensor so that data values achieved by a judging sensor are collected under the same condition as standard data values memorized in advance by nullifying variation factors of detection data that are caused by variation of the light amount of a light emitter, the effect of external temperature, etc., deterioration of a light source caused by aged deterioration, etc.

In the print paper sheet checker, a symbol-and-number reading unit for print paper sheets is provided to the stacker portion of the checker, at least two places of the symbol-and-number of each print paper sheet are read out and compared to thereby make a fake or genuine judgment. The stacker is provided with a mechanism for sorting a genuine ticket and a suspicious ticket and accommodating the genuine ticket and the suspicious ticket separately from each other after the fake or genuine judgment of the print paper sheet by adding stackers in which genuine tickets and suspicious tickets are separately accommodated. A newly issued print paper sheet or a newly found information on a suspicious ticket is graded up by ROM exchange or encrypted information communication. An S-pole and N-pole arrangement is instantaneously re-ordered by magnetic flux of a special magnet immediately before a magnetic sensor to return a magnetic pattern to a normal magnetic pattern, whereby accurate magnetic data are detected.

According to the checker of the present invention, the plural kinds of print paper sheets which are initially memorized in advance can be checked by the mode switching operation, and also data of any print paper sheet can be memorized and checked at the user side. Furthermore, the checker of the present invention can be adapted to print paper sheets different in width, large-size print paper sheets and also paper sheets whose data are thinned through the circulation thereof in the market. Accordingly, there can be provided a checker that has a high feeding speed and high precision and is very compact in size as a whole of the machine. Furthermore, in addition to the effect that plural kinds of print paper sheets can be checked by the mode switching operation, a check mode for any print paper sheet can be prepared at the user side. Furthermore, the checker can be designed to be compact as a whole because of the mechanism thereof. In addition, the checker can be easily handled, and the precision is enhanced.

### BRIEF DESCRIPTION OF THE DRAWINGS

FIG. 1 is a schematic perspective view showing the whole construction of a bank bill checker according to an embodiment of the present invention;

FIG. 2 is a front view of the bank bill checker;

FIG. 3 is a plan view showing the mechanism of the bank bill checker;

FIG. 4 is a front view of the bank bill checker;

FIG. 5 is a side view of the bank bill checker;

FIG. 6 is a plan view showing the mechanism of a supply portion;

FIG. 7 is a side view of the supply portion;

FIG. 8 is a diagram showing the operation when a feed motor is rotated in the reverse direction;

FIG. 9 is a diagram showing the operation when the feed motor is rotated in the forward direction;

FIG. 10 is a front view showing a braking mechanism;

FIG. 11 is a plan view of the braking mechanism;

FIG. 12 is a diagram showing a step of a stacker;

FIG. 13 is a side view of the stacker;

FIG. 14 is a block diagram showing the mode shift and the operation;

FIG. 15 is an overall block diagram;

FIG. 16 is a flowchart showing a normal judging mode;

FIG. 17 is a flowchart showing registration of any ticket type;

FIG. 18 is a plan view showing the bank bill checker having a sorting mechanism mounted therein;

FIG. 19 is a flowchart in the case employing the bank bill checker having a sorting mechanism mounted therein;

FIG. 20 is a perspective view showing a perspective view showing the bank bill checker having a number reading unit mounted therein; and

FIG. 21 is a diagram showing a circuit of correcting data.

### DETAILED DESCRIPTION OF THE PREFERRED EMBODIMENTS

Preferred embodiments according to the present invention will be described hereunder with reference to the accompanying drawings.

The preferred embodiments of the present invention will be described on the assumption that bank bills are targeted as print paper sheets.

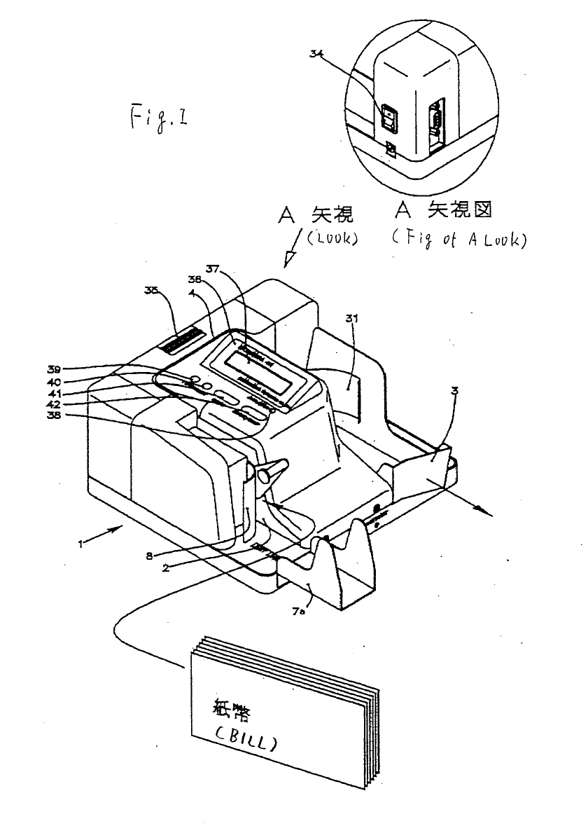

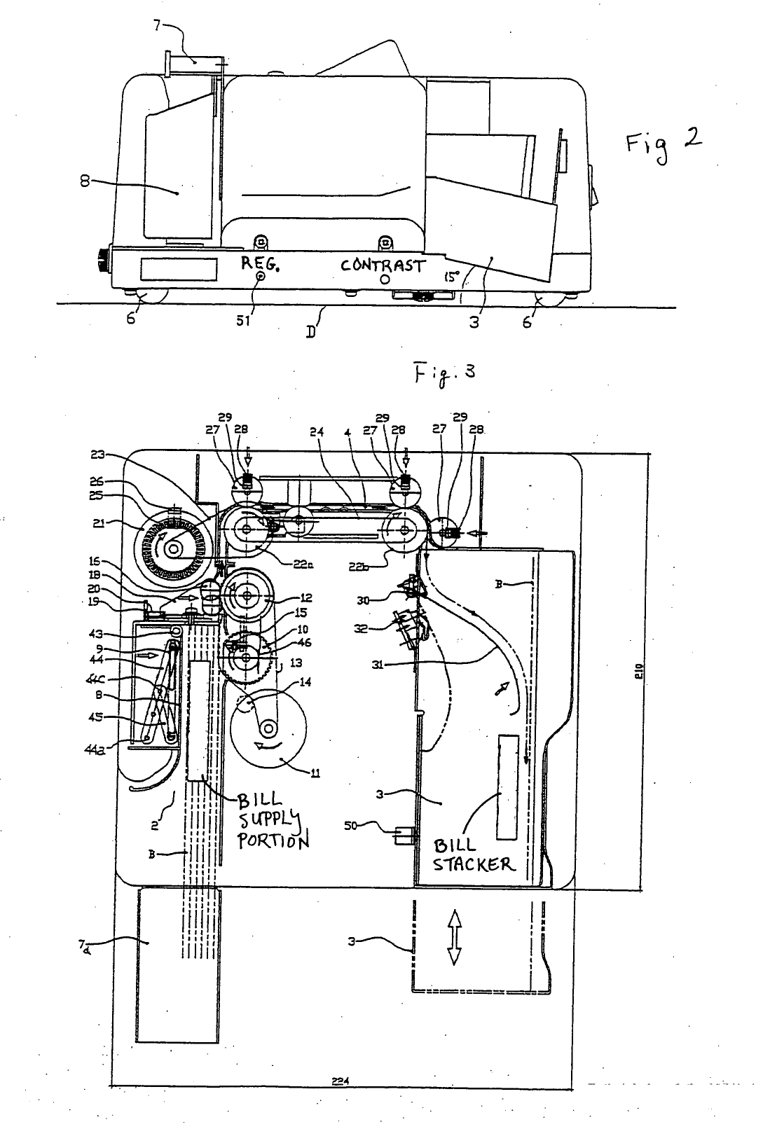

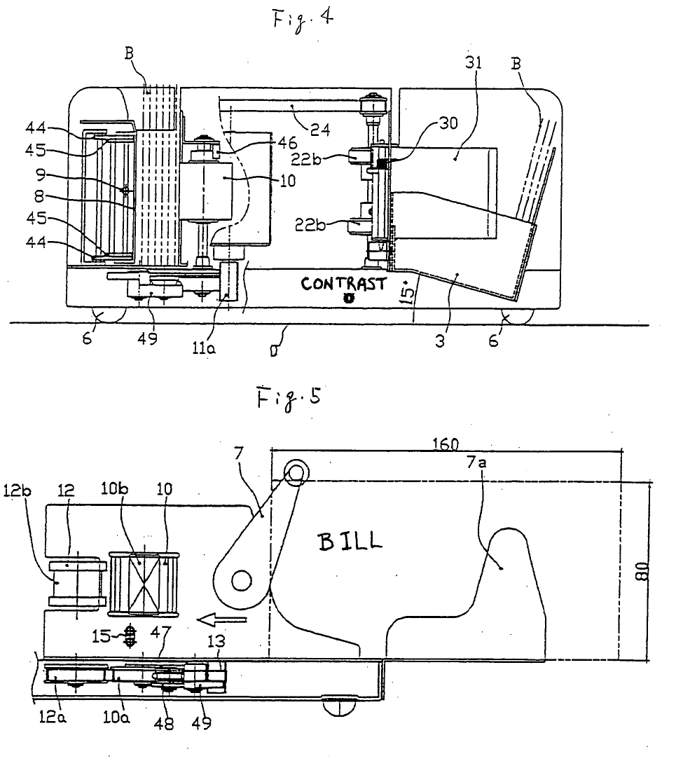

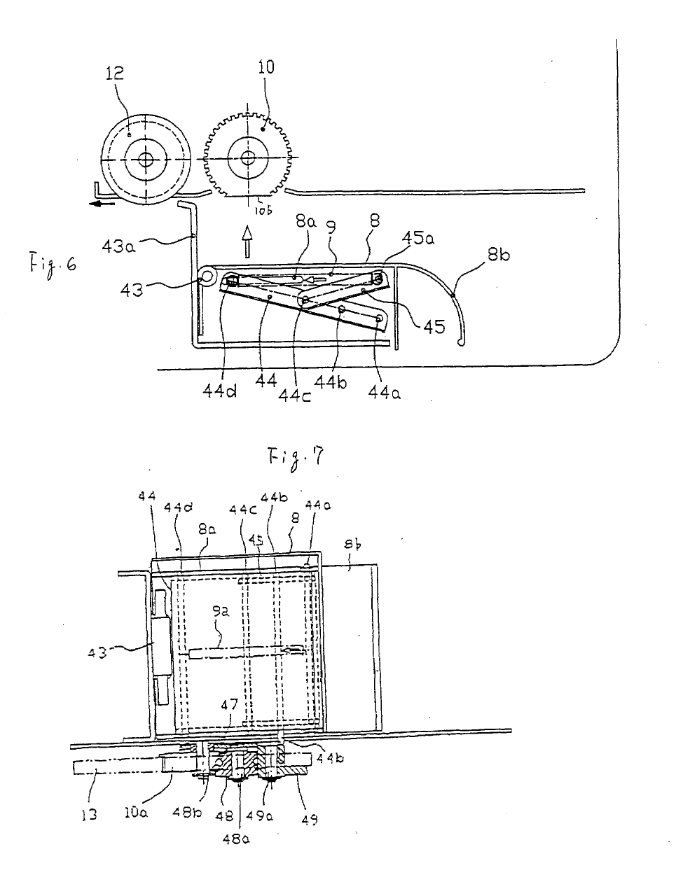

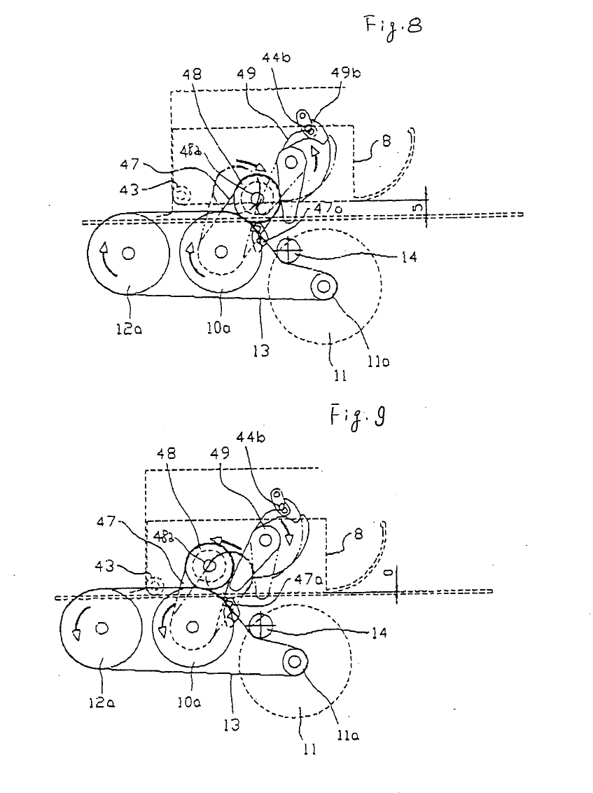

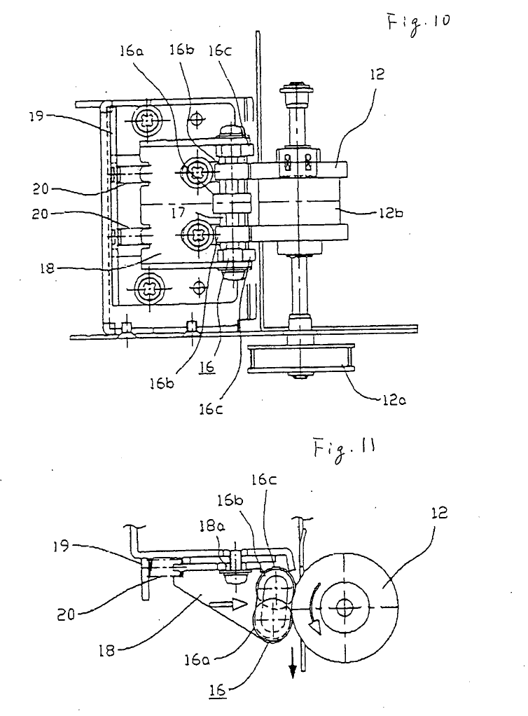

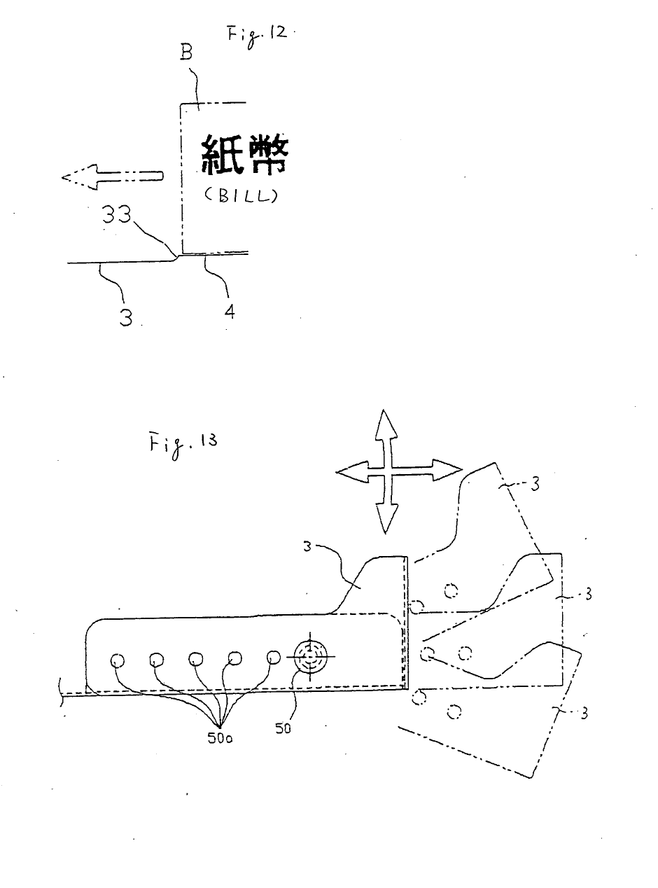

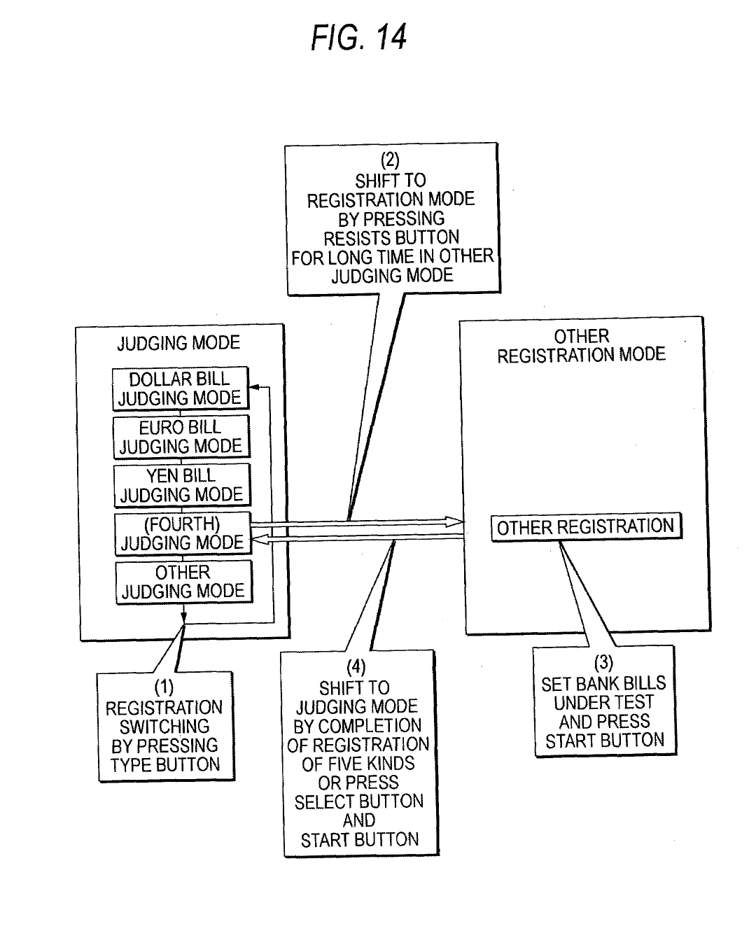

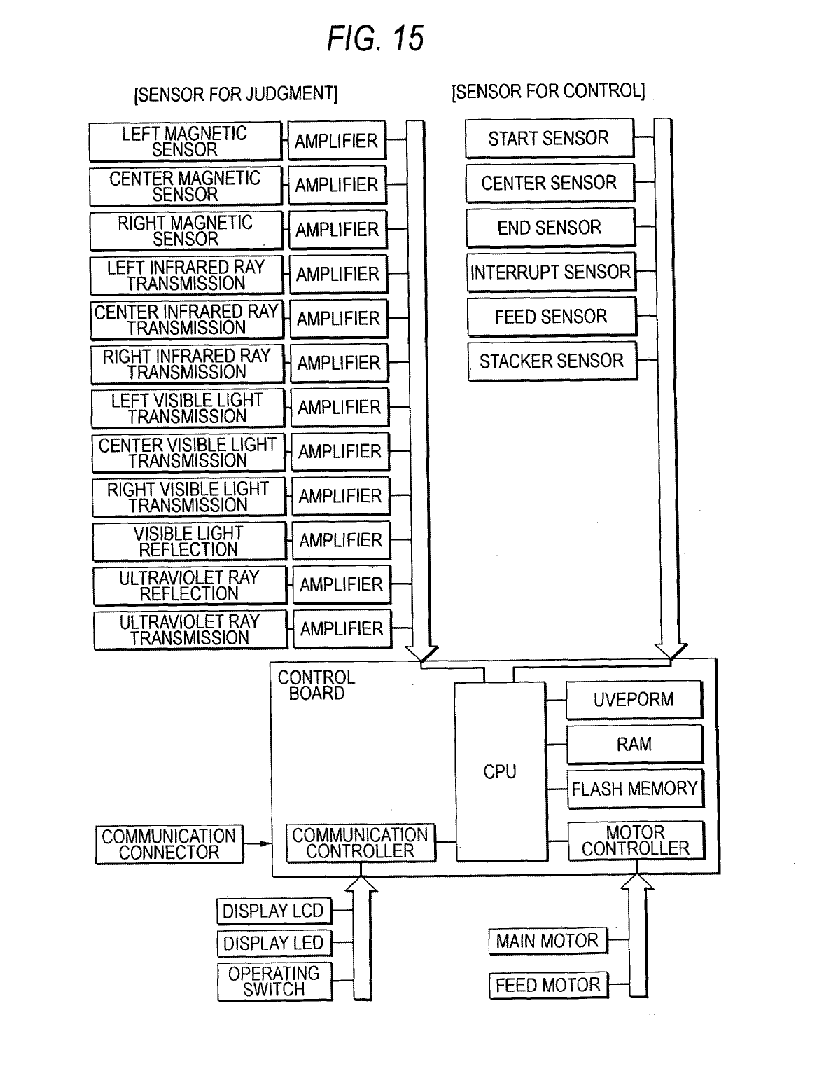

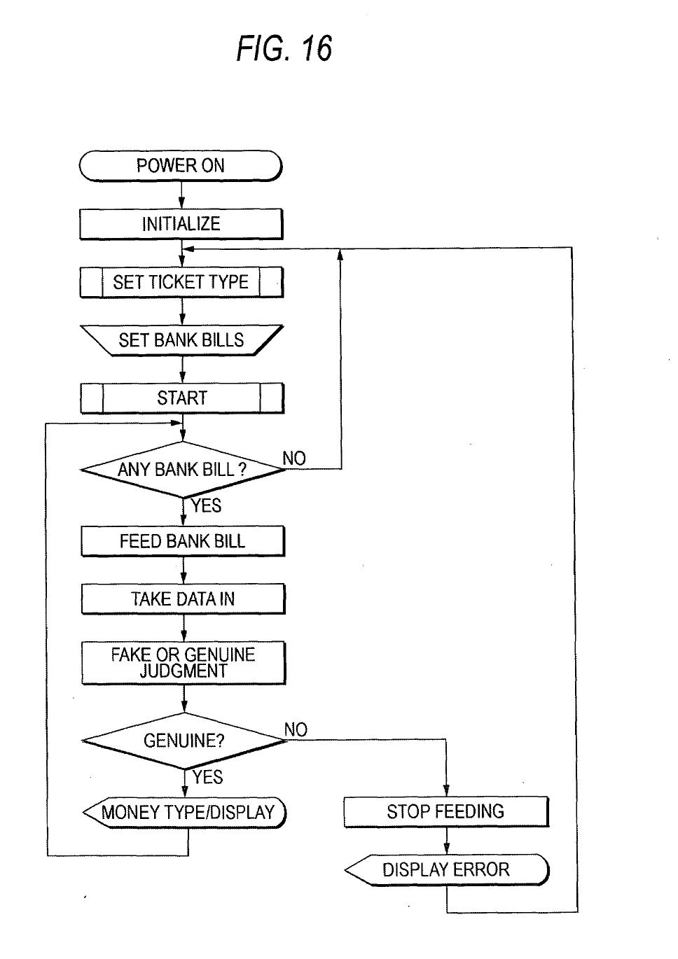

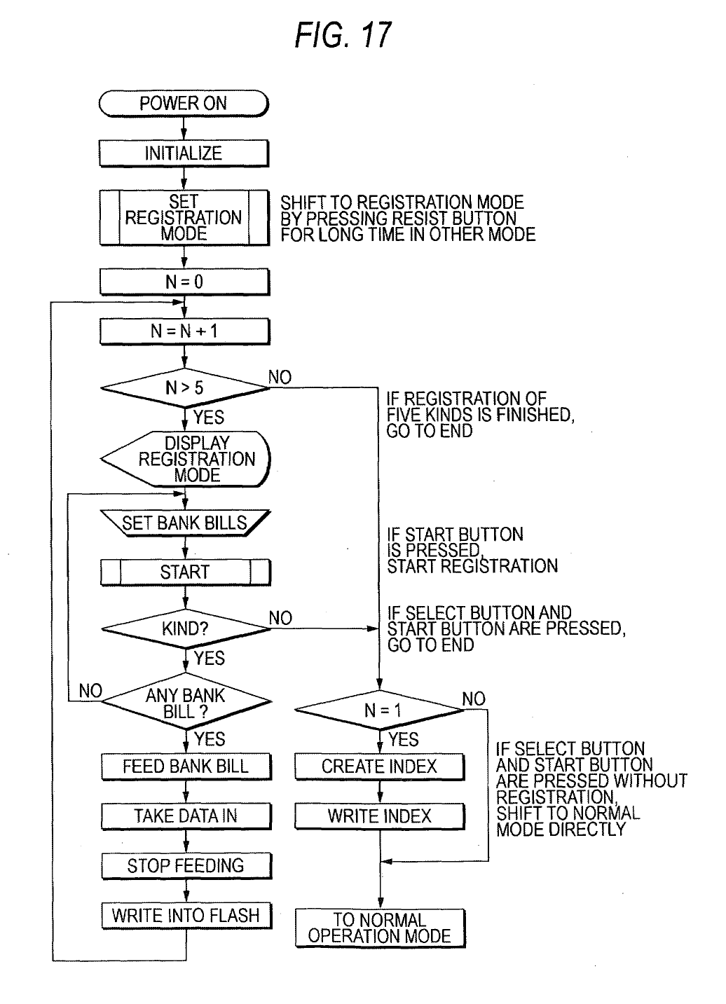

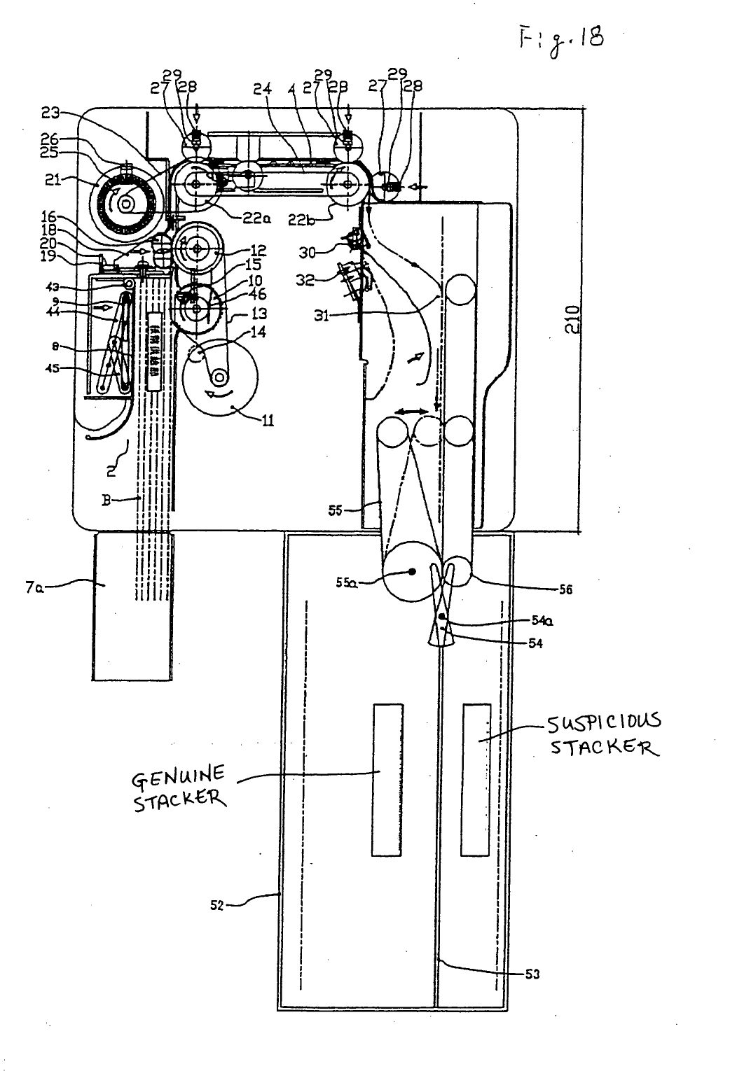

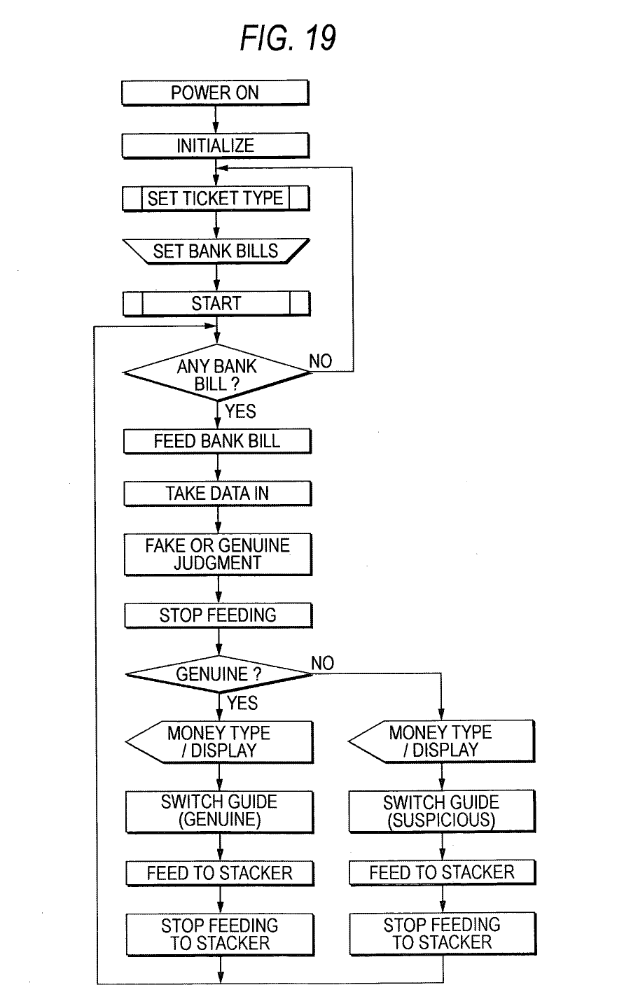

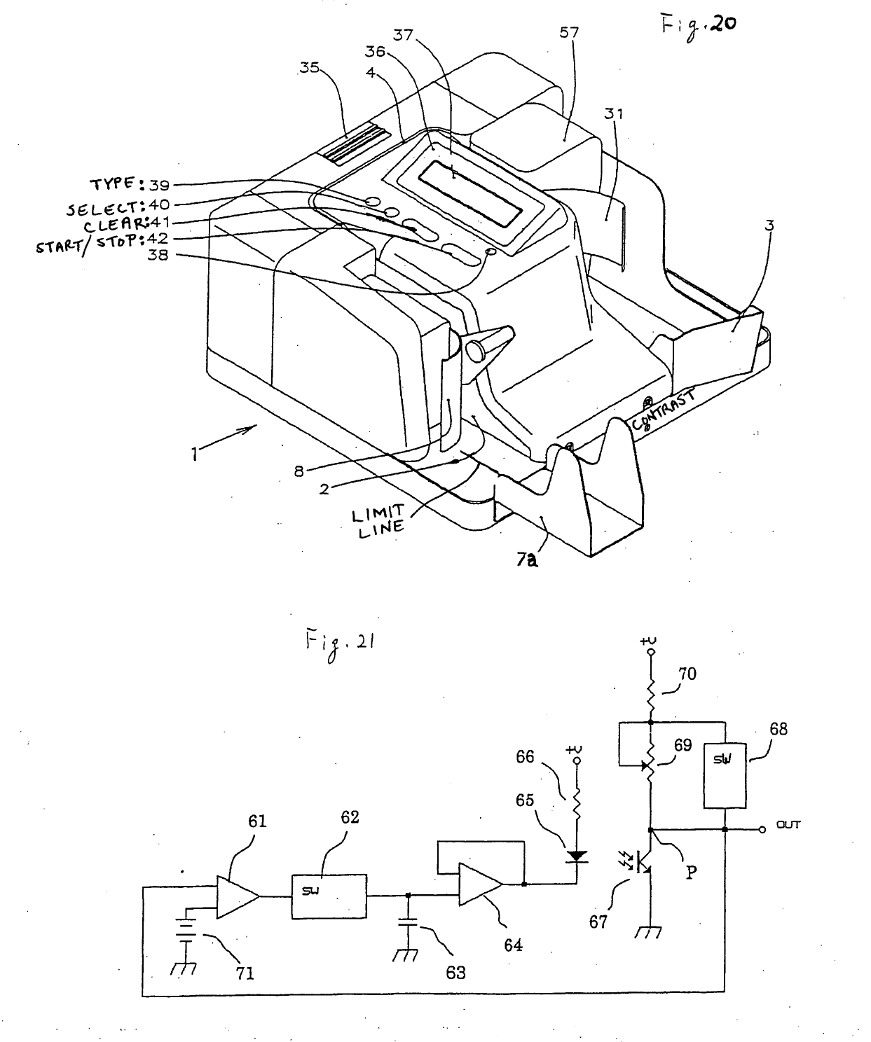

FIG. 1 is a schematic perspective view showing the whole construction of a bank bill checker according to an embodiment of the present invention, FIG. 2 is a front view of the bank bill checker, FIG. 3 is a plan view showing the mechanism of the bank bill checker, FIG. 4 is a front view of the bank bill checker, FIG. 5 is a side view of the bank bill checker, FIG. 6 is a plan view showing the mechanism of a supply portion, FIG. 7 is a side view of the supply portion, FIG. 8 is a diagram showing the operation when a feed motor is rotated in the reverse direction, FIG. 9 is a diagram showing the operation when the feed motor is rotated in the forward direction, FIG. 10 is a front view showing a braking mechanism, FIG. 11 is a plan view of the braking mechanism, FIG. 12 is a diagram showing a step of a stacker, FIG. 13 is a side view of the stacker, FIG. 14 is a block diagram showing the mode shift and the operation, FIG. 15 is an overall block diagram, FIG. 16 is a flowchart showing a normal judging mode, FIG. 17 is a flowchart showing registration of any ticket type, FIG. 18 is a plan view showing the bank bill checker having a sorting mechanism mounted therein, FIG. 19 is a flowchart in the case employing the bank bill checker having a sorting mechanism mounted therein, FIG. 20 is a perspective view showing a perspective view showing the bank bill checker having a number reading unit mounted therein, and FIG. 21 is a diagram showing a circuit of correcting data.

In these figures, reference numeral 1 represents the main body of the bank bill checker. The checker main body 1 is provided with a supply portion 2 in which a bundle of bank bills B as check targets are set at the left side of the checker main body 1 on the observers' left, and a feed path 4 is formed so as to successively feed the bank bills from the supply portion 2 through the rear side of the checker main body 1 to the stacker 3 at the right side one by one. According to this construction of the bank bill checker, if the checker main body 1 is mounted on a desk so that the front surface thereof is confronted to the right side, the supply portion is located at the front side (near side) when the bank bills B are inserted from the right side, so that it makes it easy to perform a work of setting the bank bills B while the bank bills B are aligned with one another with the surfaces thereof face the front side.

The checker main body 1 is placed in a horizontal position, so that the operation can be easily performed. In addition, the stacker 3 is inclined by about 15° so that the bank bills B are prevented from falling when they are naturally aligned with one another. In the figures, reference numeral 6 represents an installation leg portion.

The feed guide face of the supply portion 2A is provided with an upper guide 7 pivoted at one end thereof so that a bank bill is prevented from being floated when fed.

Furthermore, an auxiliary member 7a having a U-shaped section is freely detachably secured to the supply portion 2. The auxiliary member 7a may be selectively secured to the supply portion 2 by the user as occasion demands. Accordingly, the bottom surface of the supply portion 2 can be extended, so that when large-sized bank bills B are set, it can be prevented that the bank bills B fall and thus they are not aligned with one another, and also the bank bills B can be prevented from being mis-set because there is no displacement of the bank bills when they are inserted.

In the figures, reference numeral 8 represents a press plate. The press plate 8 is pivoted at one base end thereof, and a roller 43 is freely rotatably secured to the other base end of the press plate 8. The roller 43 jumps out to the left side (the feeding direction of the bank bills B) by about 0.5 mm.

Furthermore, reference numeral 44 represents a slightly longer first link member. The first link member 44 has as a supporting point an end portion at the insertion side (primary side) of the bank bills B, and rotatable around the supporting point 44a as a base point. The first link member 44 is linked to the tip of a slightly shorter second link member 45 substantially at the center position thereof through the supporting point 44c, and a slide shaft 44d which is slid in an elongated groove 8a extending along the press plate 8 and a cam shaft 44b for slidably moving the press plate 8 by a cam 49 are secured to the first link member 44.

The second link member 45 is rotatable around the link supporting point 44c of the first link member 44 and also around the base end supporting point 45a thereof, and it is linked to the press plate 8 through the base end supporting point 45a. The first link member 44 and the second link member 45 pull the slide shaft 44d and the base end supporting point 45a by a tension spring, so that the press plate 8 is slid to the left side in FIG. 16. At this time, the roller 43 abuts against a flat portion 43a, and acts on the press plate 8 so that the bank bills B are pressed against a feed roller 10.

Under the above action, the force of the tension spring 9 is small when the press plate 8 is near to the feed roller 10, however, the angle of the first link member 44 is increased. When the press plate 8 gets away from the feed roller 10, the force of the tension spring 9 is increased, however, the angle of the first link member 44 is reduced. Therefore, the press force of the press plate 8 against the bank bills B is not so varied even when the position of the press plate 8 is changed, and the bank bills B can be fed out with stable force at all times.

The acting mechanism of the press plate 8 is caused by the horizontal position set-up state of the device, and there is prevented occurrence of force acting the bank bills in the feed-out direction due to vibration by adopting horizontal sliding movement. Furthermore, the press plate 8 is formed so that the tip thereof is bent in an arcuate shape so as to serve as a guide portion 8b for insertion of the bank bills B.

A gap interval of about 5 mm is formed between the press plate 8 and the feed roller 10 at a standby time. Accordingly, even a small number of flimsy bank bills can be easily inserted. When a large number of bank bills B are inserted, the bundle of the bank bills B can press up the press plate 8.

In the figures, reference numeral 48 represents a planetary roller, and the planetary roller 48 is freely rotatably secured to a fixing shaft 48a which is fixed to a lever 47. The lever 47 is freely rotatably secured to the shaft of the feed roller 10. Since a rubber ring 48b for pressurizing a timing belt 13 is secured to the planetary roller 48, the planetary roller 48 is rotatably moved along the outer periphery of a pulley 10a, and the moving amount of this movement is regulated and controlled by a stopper portion 47a of the lever 47.

The cam 49 is freely rotatably secured to the fixing shaft 49a, and the rotation of the cam 49 moves the cam shaft 44b, so that the press plate 8 can be operated. The cam 49 is provided with a stopper portion 49b, and the press plate 8 and the feed roller 10 is controlled to be stopped at the gap interval of about 5 mm. The cam 49 is designed in any shape in the direction along which the cam 49 is rotated by the movement of the planetary roller 48 and the gap interval between the press plate 8 and the feed roller 10 is increased.

Here, the operation of the press plate 8 will be described. First, when a feed motor 11 is forwardly rotated to feed out a bank bill B in FIG. 9, the planetary roller 48 moves to the left side along the pulley 10a. At this time, the urging force of the tension spring 9 is applied to the cam 49 so that the press plate 8 moves to the feed roller 10. Therefore, the cam 49 is clockwise rotated, and the cam shaft 44b is made free, so that the press plate 8 feeds out the bank bill B while pressing the bank bill B against the feed roller 10.

When all the set bank bills B have been fed out, it is detected that there is no bank bill as shown in FIG. 8. At this time, the feed motor 11 is reversely rotated, and the planetary roller 48 moves to the right side while counterclockwise rotating the cam 49. Through this operation, the cam shaft 44b is moved and stopped at the position where the gap interval between the press plate 8 and the feed roller 10 is equal to about 5 mm, and set to a standby state again.

In connection with the reverse rotation of the feed motor 11, a light load is applied to the feed roller 10 by a leaf spring 46 at all times. This load prevents the bank bill from being fed out when the feed motor 11 is reversely rotated.

A timing belt 13 for reducing the operation noise is suspended between pulleys 10a and 12a provided to the lower ends of the rotational shafts of the feed roller 10 described above and a brake roller 12 described later, and these elements are driven. In the figures, reference numeral 14 represents an idler for preventing sagging of the timing belt 13.

Jags are formed on the outer peripheral surface of the feed roller 10 in the longitudinal direction so as to prevent attachment of dust, oil, etc., thereby preventing slipping. Furthermore, a flat portion 10b is formed at a part of the outer peripheral surface of the feed roller 10. Therefore, the bank bill is fed out while tapping the bank bill by an edge effect. Furthermore, the feed motor 11 for pulling the bank bill by a feed roller described later is stopped to stop the feed-out of the bank bill. In this case, a one-way clutch is installed in the feed roller so that the feed roller is freely rotatable and the bank bill is smoothly pulled by the feed roller. By the free rotation concerned, the friction force between the bank bills and among the feed roller 10, the brake roller 12 and the bank bill is applied, so that there can be prevented occurrence of such a situation that the bank bill is slip in the feed portion.

Furthermore, a check sensor 15 for detecting the presence or absence of a bank bill is provided at the back side of the supply portion 2. The presence or absence of the bank bill is checked, and if there is no bank bill, the checker is controlled so that the mechanism is prevented from operating. Furthermore, there is provided an automatic start mode for automatically driving a loading mechanism on the basis of the detection of the sensor concerned. The automatic start mode is used in combination with a start/stop button 42, and it is usable on the basis of user's selection.

The brake roller 12 is designed so that a recess 12b is formed at the center thereof because a brake described later which abuts against the brake roller 12 is designed in a comb-shape. The recess 12b is formed to avoid such a situation that the brake abuts against the brake roller 12 at only one point and thus the bank bills are deviated or overlapped with one another that the brake bills cannot be stably fed out. A one-way clutch is likewise installed in the brake roller 12 as in the case of the feed roller 10, and thus the brake roller 12 can be smoothly operated when the bank bill is pulled by the feed roller.

Furthermore, in the figures, reference numeral 16 represents a brake having five brake members 16a, 16b and 16c which are arranged in a comb-shape. The brake members 16a, 16b and 16c are secured to a fixing shaft 17 having an ellipsoidal cross section.

The brake 16 is held in a brake holder 18, and the brake holder 18 is movable by springs 20, 20 which are suspended under tension between the brake holder 18 and the bracket 19. Here, the two springs 20, 20 are provided because there are two contact points between the brake 16 and the brake roller 12, and if only one spring 20 is provided, stability could not be achieved.

The brake 16 slightly deforms overlapped bank bills by the arrangement of the brake members 16a, 16b and 16c, whereby it can surely apply the brake. If a bank bill is merely passed through the brake and the brake roller 12, the brake would be hardly applied to the bank bill due to ruck or the like of the bank bill, and also when the brake force is strengthened, the load of the motor is increased, so that the bank bill is damaged. Furthermore, if the brakes are arranged only on a line, the bank bill would be linearly moved, and thus it would be difficult to separate overlapped bank bills. In the figures, reference numeral 18a represents a space for movement.

Reference numeral 21 represents a feed motor 21. A timing belt 23 is suspended between the feed motor 21 and two first feed rollers 22a which are secured to one shaft to rotate the first feed roller 22a. Furthermore, a timing belt 24 is also suspended between the first feed rollers 22a and two second feed rollers 22b which are secured to one shaft. The second feed rollers 22b are rotated by the rotating force of the first feed rollers 22a.

A rotating plate 25 having slits formed radially at equal intervals is secured to the motor shaft of the feed motor 21, and a photo-interrupt or 26 detects the slits of the rotating plate 25 to thereby measure the length of a passing bank bill.

Feed auxiliary rollers 27 are pressed against the first and second feed rollers 22a and 22b by springs 28, whereby the bank bill is fed while pinched between each of the first and second feed rollers 22a and 22b and each of the feed auxiliary rollers 27. A feed auxiliary roller 27 is also provided to the corner portion of the second feed roller 22b which faces the stacker 3. Reference numeral 29 represents a set piece for preventing abrasion of the shaft of the feed auxiliary roller 27.

In order to press a bank bill against a magnetic sensor, a feed auxiliary roller 27 having the structure described above is also used in the magnetic sensor portion although it is not particularly shown in the figures.

Furthermore, bank bills which have been fed and checked by an optical system, a magnetic sensor in the feed path are fed to the stacker 3, and successively stacked and aligned in the stacker 3. The stacker 3 is provided with a stacker guide 31 whose base end portion is urged by a spring 30, and the stacker guide 31 makes the bank bills be naturally aligned with one another while pressing the bank bills.

In the figures, reference numeral 32 represents a limit switch which is pressed by the stacker guide 31 when the stacker 3 is filled with bank bills, and the mechanism is stopped when the limit switch 32 is input.

The stacker 3 can be slid to the front side to be adaptive to large-sized bank bills, etc., and a step 33 of about 1 mm is formed at the portion through which the bank bills are fed from the feed path 4 into the stacker 3, whereby occurrence of jam can be prevented when the bank bills naturally fall.

Furthermore, in the figures, reference numeral 34 represents a power supply switch, reference numeral 35 represents an opening push button of a sensor unit portion, and reference numeral 36 represents a display panel. On the display panel 36 are arranged LCD 37 for displaying various kinds of characters, an LED group 38 for displaying ticket types (bank bill types), and a type button 39, a select button 40, a clear button 41 and a start/stop button 42 which are push type buttons.

The mechanism of this embodiment is constructed as described above. A control board having CPU as shown in the block diagram of FIG. 15 is provided as a control system. CPU is added with a general control mechanism, UVEPROM and RAM for temporary storage, calculation, etc. to check fake or genuine, and also with a flash memory for storing data for any print paper sheet.

Data of three kinds of bank bill types of euro bill, yen bills and dollar bill are initially stored in UVEPROM in this embodiment, and the bank bill types are successively switched by pushing the type button 39. Other mode is also provided in the switching order, and a judging mode for any ticket type (not limited to the bank bill type) can be set by the user. The mode can be shifted to a registration mode by pushing the resist button 51 for a long time in the other mode. In this case, any five (five kinds) print paper sheets are fed. However, even when one print paper sheet is passed, the mode can be shifted to the judgment mode by pushing the select button 40 and then pushing the resist button 51.

When the bill check is executed in this embodiment, the power supply switch 34 is turned on, the ticket type is set by the type button 39 and then target bank bills are set in the supply portion 2. Subsequently, when the start switch 42 is input, the sensor 15 acts to detect the presence or absence of a bank bill, and the loading mechanism is actuated. The data of a fed bank bill is taken by the optical system, the magnetic sensor for the judgment, and compared with the data of the genuine bank bill.

Here, if the bank bill concerned is judged to be genuine, the bank bill is directly fed to the stacker 3, and the bill type or the like is displayed on LCD 37. The display content is switched by the select switch 41, and the total amount of money and the content thereof (the bill type, the number of bills, etc.) can be displayed. If the bank bill concerned is judged to be abnormal, the feeding of the bank bill concerned is stopped, and an error is displayed on LCD 37. Then, the abnormal bank bill is picked up from the stacker 3 and then the checking operation is re-started.

Furthermore, in order to check any bill types (bank bills of other countries, coupons, etc.) in addition to the three bill types described above, the other mode is set by operating the type button 39 and pushing the resist button 51 for a long time at the user side, whereby the mode is shifted to the registration mode. Here, any five kinds of bill types can be registered, and data of any ticket type are written into the flash memory. However, this registration is carried out on at least one type of the five bill types, the select button 40 is pushed and then the resist button 51 is pushed, whereby the mode can be switched to the judgment mode. Here, if the select button 40 is pushed and then the start switch 42 is pushed without registering any bill type, the mode is returned to the normal mode. Furthermore, the flash memory can be erased and rewritten, and thus the content thereof can be successively changed as occasion demands.

Plural holes 50a are linearly arrange on a line on the side wall surface of the stacker 3, and a ball plunger 50 can be fitted in each hole 50a. Accordingly, it is unnecessary to provide a special stopper, and the stacker 3 is moved with a feeling of click. The stacker 3 can be easily detached in the slide direction and in the vertical direction, which can prevent a worker from being injured and also prevent the checker from being damaged or the like.

LCD 37 is inclined at an angle so that the worker can easily view the LCD 37, and LED 38 displays not only the ticket type, etc., but also information as to which one of an automatic start mode and a manual button operating start mode is set.

A conventional print paper sheet checker displays an error by changing the alarm sound and the color of LCD when a print paper sheet is judged not to be genuine, and set to a standby state. At this time, an operator removes the suspicious print paper sheet and then re-starts to actuate the checker. Even when the set state of a print paper sheet is not good and thus it cannot be accurately fed, there may be a case where the print paper sheet concerned is judged not to be a genuine one, and thus an error is output. Therefore, when a user carries out a required different work during use of the checker, there is a case where the operator cannot perceive that the checker is stopped and thus the consumed work time has been wasted. Therefore, the stacker portion is required to be newly provided with a stacker having a mechanism for sorting suspicious print paper sheets and genuine print paper sheets.

In the case of FIG. 18, a sorting stacker 52 is appended to the checker. Print paper sheets which are successively fed one by one and subjected to the fake or genuine judgment are temporarily fed to the stacker 3, and a switching guide 54 which is rotated around the supporting point 54a is switched on the basis of the fake or genuine judgment result by a solenoid or the like. Then, the planetary belt 55 is rotated, and the suspicious print paper sheets and the genuine print paper sheets are sorted to and accommodated in the sorting stacker 52. The sorting is carried out by exchanging ROM. If there is any bank bill in the supply portion after the sorting and accommodating operation is completed, the next one bank bill is fed. The driving source of the planetary belt 55 is based on the motor. However, when the motor is stopped, the planetary belt is on standby at a free position, and when the motor is rotated, the planetary belt is rotated to the feed belt side and comes into contact with the feed belt, so that the print paper sheet is fed. In the figures, reference numeral 53 represents a partition plate through which the suspicious print paper sheets and the genuine print paper sheets are isolated from one another. Reference numeral 56 represents a feed belt.

Furthermore, suspicious ticket information of each of ticket types and bill types are memorized in the checker in advance. Particularly, features of suspicious tickets frequently appear in the pattern of a portion printed with magnetic ink on the basis of magnetic reaction level and the length of the section length of the presence or absence of magnetism. Furthermore, plural photosensors of different wavelengths are used in the judgment sensor portion, and the difference in reactions of the photosensors is grasped as a feature point. The difference in reactions from those of the genuine ticket is set as feature information of the suspicious ticket, and when the information achieved is coincident with the feature information of the suspicious ticket, the ticket is judged as a fake.

When a print paper sheet (for example, circulated bank bill) has a fold line, an aged deterioration, a partial stain or the like, the print paper sheet concerned may be judged as a suspicious one due to the effect of the fold line, the stain or the like at that portion. In order to prevent this problem, the detection data at each calculated position of ¼, ½ and ¾ of the length of the print paper sheet are omitted so that the effect of the fold line is excluded. Furthermore, variation of data caused by the overall deterioration or a partial stain of the print paper sheet is compared with the data of plural kinds of genuine ticket types which are memorized in advance, and the error from a reference pattern is multiplied by itself. Accordingly, the error is calculated as an error accumulative total like the error is further increased when the error is large, and the error is further reduced when the error is small, and then the calculation result is averaged, whereby the fake or genuine judgment can be accurately performed even when there is any overall deterioration or partial stain.

Before a print paper sheet which is inserted from the supply portion and loaded is measured by the judging sensor (i.e., before light emission data is measured), that is, under a standby state, analog switches 62 and 68 are turned on to perform correction. When the analog switches 62 and 68 are turned on, a light emitting diode 65 and a phototransistor 67 form a closed loop, and in any case, the contact point P corresponding to the collector side of the phototransistor 67 is a potential which is accurately dependent on a reference voltage irrespective of the positional relationship between the light emitting diode 65 and the phototransistor 67 (irrespective of when the distance therebetween is increased or reduced). When a print paper sheet is inserted under the above corrected state, the analog switches 62 and 68 are turned off, and the collector resistance 69 of the phototransistor 67 is adjusted so that the brightness when a print paper sheet is inserted and the brightness when no print paper sheet is inserted are set to the same level. That is, the analog switches are set to ON state before light emission data are measured, and then the analog switches are set to OFF state at the measurement time of the light emission data, whereby the light emission state of the light emitting diode is corrected before the measurement, and the light emission data from the print paper sheet is measured under the corrected state. That is, the detection data can be achieved from the print paper sheet under the judging sensor state which is fixed at all times irrespective of the temperature drift caused by the external temperature, the deterioration of the light source caused by the aged deterioration, etc. and also corrected with high precision. Reference numerals 61, 64 represent amplifiers, reference numeral 63 represents a capacitor, reference numerals 66 and 70 represent resistors and reference numeral 71 represents a battery.

Characters of respective digits of a symbol-and-number are recognized from image data of a symbol-and-number area of a print paper sheet (for example, a bank bill or the like) by a symbol-and-number reading unit 57 for print paper sheets which is mounted in the stacker portion, and two places of the symbol-and-number are compared. When the symbol-and-number is coincident, the print paper sheet is treated as a genuine one, and if the symbol-and-number is not coincident, the print paper sheet is treated as a suspicious one. In addition to the normal fake and genuine judgment, the symbol-and-number of the print paper sheet is read and then compared, so that the fake and genuine judgment can be performed with higher precision.

Information on newly issued print paper sheets or newly found suspicious print paper sheets can be graded up by ROM exchange or means such as encrypted information communication or the like.

S-pole and N-pole arrangement is disturbed or magnetic force is weakened in the pattern of the portion of a print paper sheet which is printed with magnetic ink. Therefore, the disturbed S-pole and N-pole arrangement is instantaneously ordered or the magnetic pattern is returned to a normal one by the magnetic flux of some special magnet located immediately before the magnetic sensor to achieve accurate magnetic data, whereby the fake or genuine judgment can be performed with high precision.

The checker according to the present invention has the above construction, and thus it is usable in all the fields where cash is treated. Furthermore, the checker can be broadly used to check other printed materials such as tickets, marketable securities, etc.

1. A print paper sheet checker comprising a supply portion for supplying print paper sheets, a feeding mechanism and a feeding path that feed the print paper sheets set in the supply portion one by one, a check sensor provided to the feeding path, a stacker for successively accommodating print paper sheets passed through the feeding path, a display portion for making various kinds of displays and plural operating switches, wherein as the print paper sheets to be checked, plural kinds of tickets are set to be adaptable in advance and any ticket type can be further added.

2. The print paper sheet checker according to claim 1, wherein the operating switches include at least a type switch, a select switch, a clear switch and a start/stop switch that are designed as push button types.

3. The print paper sheet checker according to claim 2, wherein the type switch successively switches an association with plural registered ticket types and is equipped with another mode, and data of any genuine ticket type is storable in a memory by operating the other mode.

4. The print paper sheet checker according to claim 3, wherein the memory for registering the data of any genuine ticket type is a flash memory.

5. The print paper sheet checker according to claim 1, wherein the supply portion of the checker is equipped with an auxiliary guide bar adapted to large-size print paper sheets.

6. The print paper sheet checker according to claim 1, wherein the supply portion of the checker is equipped with a print paper sheet pressing plate that is urged by a spring and bent in an obtuse angle.

7. The print paper sheet checker according to claim 1, further comprising a feed roller having jags formed on the outer peripheral surface thereof, wherein a flat portion is formed on a part of the outer peripheral surface of the feed roller and a one-way clutch is installed in the feed roller.

8. The print paper sheet checker according to claim 7, further comprising a brake roller containing a one-way clutch and a brake member that is urged against the brake roller by a spring and arranged in a comb-shape, the brake roller and the brake member being provided in a feed path subsequent to the feed roller.

9. The print paper sheet checker according to claim 7, further comprising a pinching roller that is urged and pressed against the feed roller by a spring.

10. The print paper sheet checker according to claim 8, wherein the stacker is located to be slightly lower than the feed path.

11. The print paper sheet checker according to claim 1, wherein the stacker is equipped with an aligning guide that is urged by a spring and bent in an obtuse angle, and a limit switch pressed by the aligning guide.

12. The print paper sheet checker according to claim 11, wherein the stacker is slidable to a front side.

13. The print paper sheet checker according to claim 1, wherein the stacker is inclined.

14. The print paper sheet checker according to claim 5, wherein the auxiliary guide bar is at least one of rotatable by pivoting one end thereof and detachable by using a screw.

15. The print paper sheet checker according to claim 6, wherein the pressing plate is equipped with a slidable link mechanism and a tension coil spring.

16. The print paper sheet checker according to claim 7, wherein a light load is applied to the feed roller by a leaf spring at all times.

17. The print paper sheet checker according to claim 15, wherein a degree of interval is formed between the pressing plate and the feed roller in a standby state, and a feed motor rotates in the forward/reverse direction and is provided with a cam that is delinked based on a rotational direction of the feed motor.

18. The print paper sheet checker according to claim 12, wherein the stacker is held by a ball plunger.

19. The print paper sheet checker according to claim 1, wherein the supply portion is provided with a detection sensor switch so as to enable automatic start.

20. The print paper sheet checker according to claim 1, wherein information on a feature portion of a suspicious ticket type is installed in a program, suspicious ticket information is memorized in advance, and high-precision fake or genuine judgment which is not affected by stain, ruck, fold line and age deterioration is performed on based on an algorithm by software and hardware.

21. The print paper sheet checker according to claim 1, wherein data values are achieved from a print paper sheet inserted and loaded from the supply portion by a judging sensor, and a fake or genuine judgment is carried out by software and hardware based on an algorithm corresponding to at least one of stain, ruck, fold line, and age deterioration, which are caused by circulation.

22. The print paper sheet checker according to claim 1, further comprising a unit for correcting an output of a photodetecting sensor so that data values achieved by a judging sensor are collected under a same condition as standard data values memorized in advance by nullifying variation factors of detection data that are caused by at least one of variation of a light amount of a light emitter, external temperature effects, and deterioration of a light source caused by age deterioration.

23. The print paper sheet checker according to claim 1, wherein a symbol-and-number reading unit for print paper sheets is provided to the stacker portion of the checker, and at least two places of the symbol-and-number of each print paper sheet are read out and compared to thereby make a fake or genuine judgment.

24. The print paper sheet checker according to claim 1, wherein the stacker is provided with a mechanism for sorting a genuine ticket and a suspicious ticket and accommodating the genuine ticket and the suspicious ticket separately from each other after a fake or genuine judgment of the print paper sheet by adding stackers in which genuine tickets and suspicious tickets are separately accommodated.

25. The print paper sheet checker according to claim 1, wherein at least one of a newly issued print paper sheet and newly found information on a suspicious ticket is graded up by at least one of ROM exchange and encrypted information communication.

26. The print paper sheet checker according to claim 1, wherein an S-pole and N-pole arrangement is instantaneously re-ordered by magnetic flux of a special magnet immediately before a magnetic sensor to return a magnetic pattern to a normal magnetic pattern, whereby accurate magnetic data are detected.
